(19) United States
(12) Patent Application Publication
(10) Pub. No.: US 2011/0203528 A1
(43) Pub. Date: Aug. 25, 2011

(54) PET HOUSING ENCLOSURE

(75) Inventors: Melaney Northrop, Mansfield, TX (US); Adam Weber, Keller, TX (US)

(73) Assignee: DOSKOCIL MANUFACTURING COMPANY, INC., Arlington, TX (US)

(21) Appl. No.: 13/030,797

(22) Filed: Feb. 18, 2011

Related U.S. Application Data
(63) Continuation-in-part of application No. 12/350,285, filed on Jan. 8, 2009.
(60) Provisional application No. 61/429,005, filed on Dec. 31, 2010.

(51) Int. Cl. A01K 1/03

(52) U.S. Cl. 119/497; 119/498

(57) ABSTRACT

A pet housing having selectively coupleable parts is provided. In particular, in some embodiments, a pet housing having a top portion, a middle portion and a bottom portion is provided. Each of the top, bottom and middle portions are selectively coupleable with each other portion. In particular, the top portion and bottom portion may each be coupled to the middle portion to form a pet housing. Additionally, the top portion and bottom portion may be coupled together to form a cavity in which the middle portion may be stored.

### CROSS-REFERENCE TO RELATED APPLICATION

The present application is a continuation-in-part of U.S. patent application Ser. No. 12/350,285, filed Jan. 8, 2009, entitled “Pet Housing With Zippered Closure,” and also claims the benefit under 35 U.S.C. §119(e) of U.S. Provisional Patent Application Ser. No. 61/429,005, filed Dec. 31, 2010, entitled “Pet Housing With Closure,” each of which is expressly incorporated by reference in its entirety.

### TECHNICAL FIELD

The present application relates to pet housings, such as, for example, a pet kennel, and more particularly to a pet housing having portions interconnected by a zipper and which are nestable for compact storage, shipping and point of sale display.

### BACKGROUND

A variety of pet kennels having connectable upper and lower portions have been designed in order to allow for compact storage of these components. These kennel designs typically require a user to connect the upper and lower portions either with a latch or fastener such as nuts and bolts. Such fasteners typically require the use of tools to complete the assembly, and such fasteners may be easily lost.

Pet kennels are also designed in upper and lower portions to allow for compact storage, shipping and point of sale display. The size or height of the nested configuration of the upper and lower portions is generally equal to one half of the height of the assembled kennel. Therefore, the height of the nested configuration of the portions of the kennel cannot be made less than approximately one half the total height of the kennel. Also, in the nested configuration, the entry way door of the kennel must be detached and removed from the kennel. The doors are often misplaced or lost, and there are assembly requirements to reconnect the door to the kennel when in the assembled position.

Therefore, a need exists for a pet kennel which is easy to assemble, and has improved nestability of component parts.

### SUMMARY

In accordance with embodiments of the present disclosure, a pet housing includes a top portion having a continuous edge. A bottom portion is provided and has a continuous edge. A middle portion is disposed between the top and bottom portions. The middle portion includes a continuous top edge and a continuous bottom edge. A first zipper is operable between an open and closed position to selectively interconnect the top portion continuous edge to the middle portion continuous top edge. A second zipper is operable between an open and closed position to selectively interconnect the bottom portion continuous edge to the middle portion continuous bottom edge. When the zippers are in the closed position, the top, bottom and middle portions form an enclosed area. When the zippers are in the open position, the top and bottom portions are completely detachable from the middle portion to allow the portions to nest.

In some embodiments, a selectively separable pet housing is provided that allows for at least two separable portions to be coupled together to form a cavity. In particular, a top portion and a bottom portion may each be selectively coupled to a middle portion or to each other. When coupled together, the top and bottom portion form a cavity in which the middle portion may be stored. When the top and bottom portion are each coupled to the middle portion, a pet housing is created in which a pet may be housed.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

For a more complete understanding of the present disclosure and for further advantages thereof, reference is now made to the following description of the embodiments taken in conjunction with the accompanying drawing in which:

FIG. 1 is a perspective view of the present pet housing in the assembled position;

FIG. 2 is a right side elevational view thereof, the left side elevational view being a mirror image thereof;

FIG. 3 is a front elevational view thereof;

FIG. 4 is a top plan view thereof;

FIG. 5 is a rear elevational view thereof;

FIG. 6 is an exploded perspective view of the present pet housing illustrated in FIG. 1;

FIG. 7 is a side elevational view of the entire middle portion of the present pet housing;

FIG. 8 is an exploded perspective view of the disconnected top, bottom and middle portions of the present pet housing in the nested position;

FIG. 9 illustrates another pet housing in accordance with an alternative embodiment;

FIG. 10 is an exploded view of the pet housing of FIG. 9 when disassembled;

FIG. 11 shows a middle portion of the pet housing of FIG. 9 folded;

FIG. 12 shows the folded middle portion of FIG. 11 positioned within a bottom portion of the pet housing of FIG. 9; and

FIG. 13 illustrates a top portion and the bottom portion of the pet housing of FIG. 9 coupled together.

### DETAILED DESCRIPTION

Pet housing embodiments are disclosed which provide selective disassembly for storage, transport and/or display. In some embodiments, a pet housing is provided that includes three separable parts that may be coupled together. In some embodiments two sets of zippers may be implemented to couple the parts together. In some embodiments, at two of the separable parts may be coupled together to create a cavity in where a third part may be stored. In other embodiments, parts of the housing may be nested together when separated.

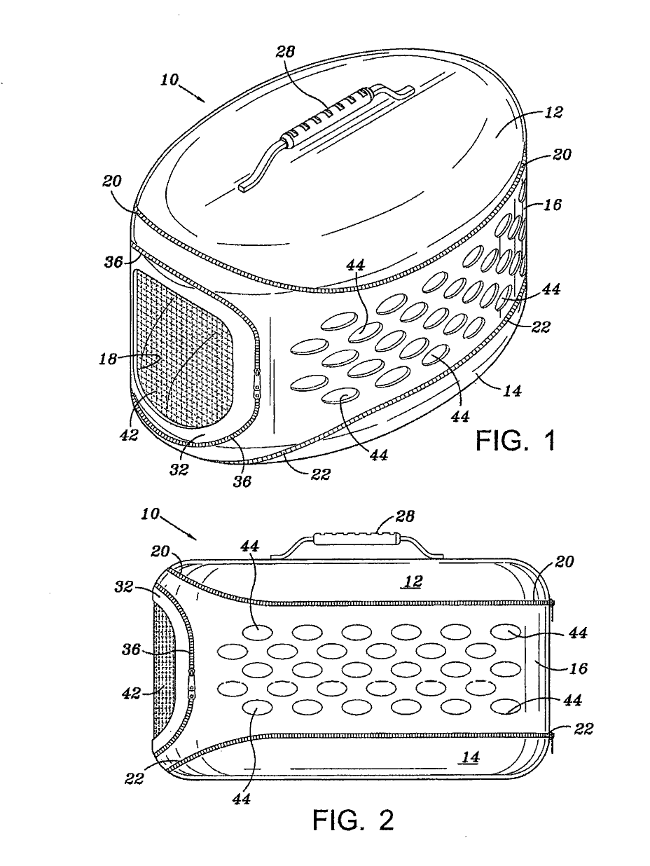

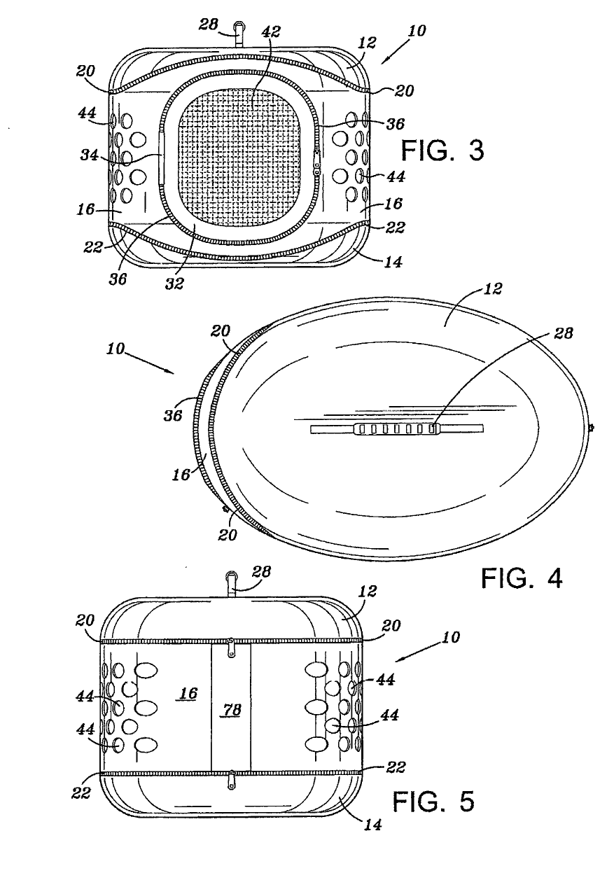

Referring simultaneously to FIGS. 1-5, the present pet housing is illustrated, and is generally identified by the numeral 10. As used herein, the term “pet housing” or “housing” includes, for example, but is not limited to, a pet kennel, pet shelter or pet carrier. Housing 10 includes a top portion 12, a bottom portion 14 and a middle portion 16. When assembled, portions 12, 14 and 16 form an enclosed area 18 for containing a pet. Top portion 12 and bottom portion 14 are essentially the same size and shape to accommodate nesting.

Top portion 12 is selectively interconnected to middle portion 16 using a first zipper 20. Bottom portion 14 of housing 10 is interconnected to middle portion 16 utilizing a second zipper 22. Zippers 20 and 22 extend around the entire housing 10, and allow portions 12, 14 and 16 to be completely detachable from one another for purposes of nesting for storage, shipping and point of sale display of housing 10. Top portion 12 of housing 10 includes a handle 28.

Middle portion 16 of housing 10 includes an entrance way 30 to enclosed area 18. Entrance way 30 is selectively closable utilizing a door flap 32 which is hingedly attached to middle portion 16 utilizing a hinge 34. Door flap 32 is selectively secured to middle portion 16 of housing 10 in a closed position utilizing a zipper 36. Zipper 36 includes teeth 38 and 40. Door flap 32 includes a ventilation mesh 42. Door flap 32 is contained within middle portion 16 and is secured to middle portion 16 to ensure that door flap 32 is not misplaced or lost when housing 10 is disassembled.

Middle portion 16 of housing 10 further includes a plurality of ventilation openings 44.

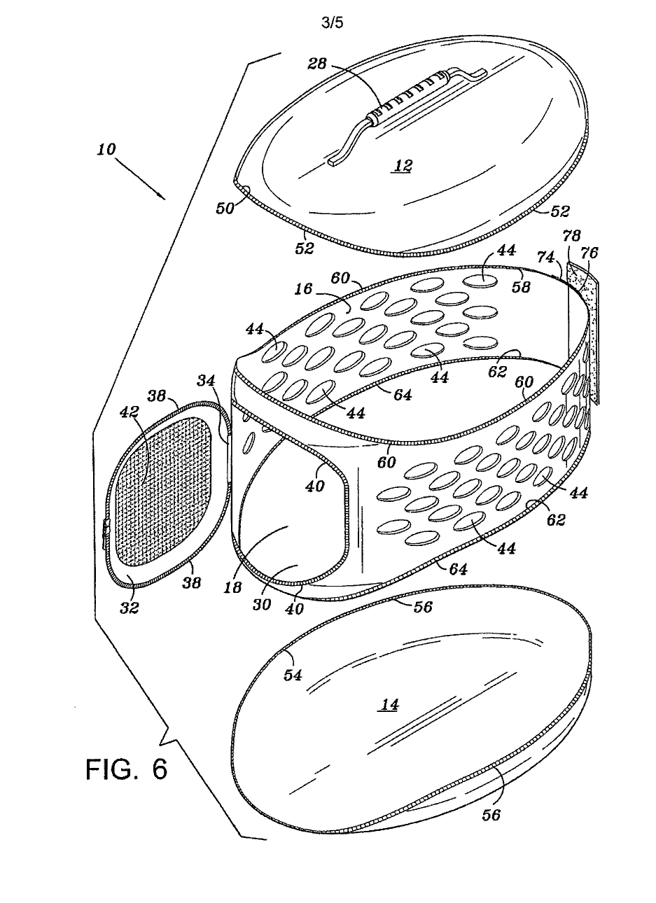

Referring simultaneously to FIGS. 1 and 6, top portion 12 includes a continuous edge 50 to which is attached a row of zipper teeth 52. Bottom portion 14 includes a continuous edge 54 to which is attached a row of zipper teeth 56. Middle portion 16 of housing 10 includes a top continuous edge 58 to which is attached a row zipper teeth 60. Middle portion 16 further includes a bottom continuous edge 62 to which is attached a row of zipper teeth 64. Zipper teeth 52 and 60 comprise zipper 20. Zipper teeth 56 and 64 comprise zipper 22. Zipper teeth 52 extend completely around the edge 50 of top portion 12. Similarly, zipper teeth 56 extend completely around edge 54 of bottom portion 14. Zipper teeth 60 and 64 extend continuously around edges 58 and 62, respectively, of middle portion 16. Therefore, it can be seen that top portion 12 and bottom portion 14 are completely severable from middle portion 16 of housing 10 when zippers 20 and 22 are in an open position. Portions 12, 14 and 16 are integrally connected to one another when zippers 20 and 22 are in a closed position.

FIG. 6 illustrates door flap 32 in an open position such that zipper 36 is open to thereby provide access to enclosed area 18 of housing 10.

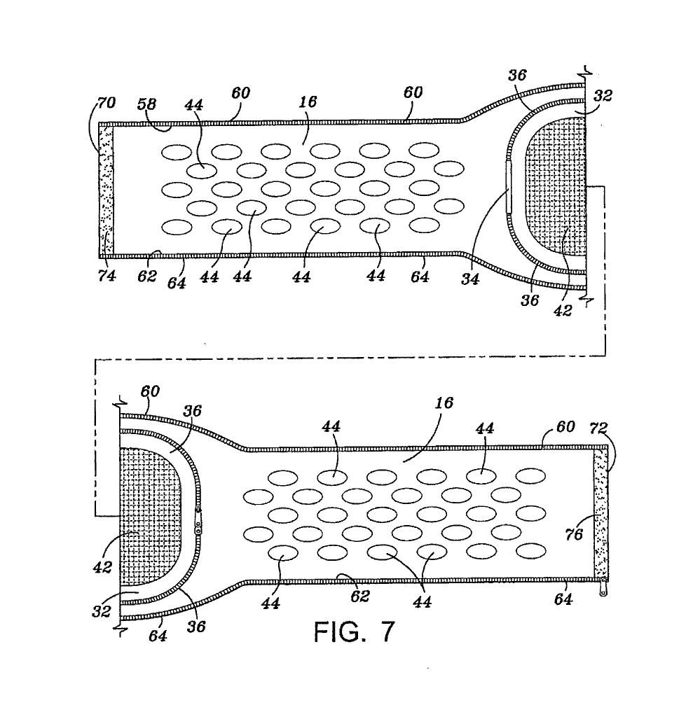

FIG. 7 illustrates middle portion 16 detached from top portion 12 and bottom portion 14 of housing 10. Door flap 32 is in a closed position with zipper 36 in the closed position. Middle portion 16 includes ends 70 and 72 to which are attached a fastener such as for example, a Velcro® strip 74 and 76, respectively. Ends 70 and 72 are attached using a Velcro® strip attachment 78 (FIG. 5).

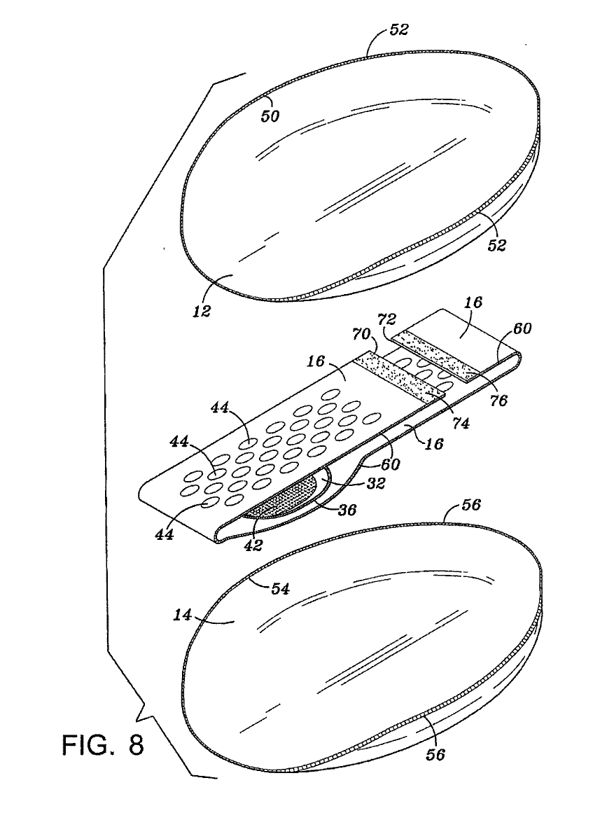

FIG. 8 illustrates housing 10 in a nested position of top portion 12, bottom portion 14 and middle portion 16. Top portion 12 is turned upside down to mate with bottom portion 14. Middle portion 16 is folded and inserted between top portion 12 and bottom portion 14 to provide for a compact configuration for storage, shipping and point of sale display for housing 10. Since top portion 12 and bottom portion 14 are essentially the same size, portions 12 and 14 nest together with minimal separation between these components. Middle portion 16 is easily foldable and inserted between nested top portion 12 and bottom portion 14.

Portions 12, 14 and 16 may comprise plastic sheet material such as, for example, ethylene-vinyl acetate (EVA), EVA foam, foamed poly-ethylene, PVC, nitrile rubber and nylon. Portions 12, 14 and 16 may include different colored and patterned materials to create a variety of aesthetically pleasing looks and assortments for housing 10.

Bottom portion 14 of housing 10 can be used independently of housing 10 as a pet bed. Middle portion 16 together with bottom portion 14 can be used without top portion 12 as a pet exercise pen.

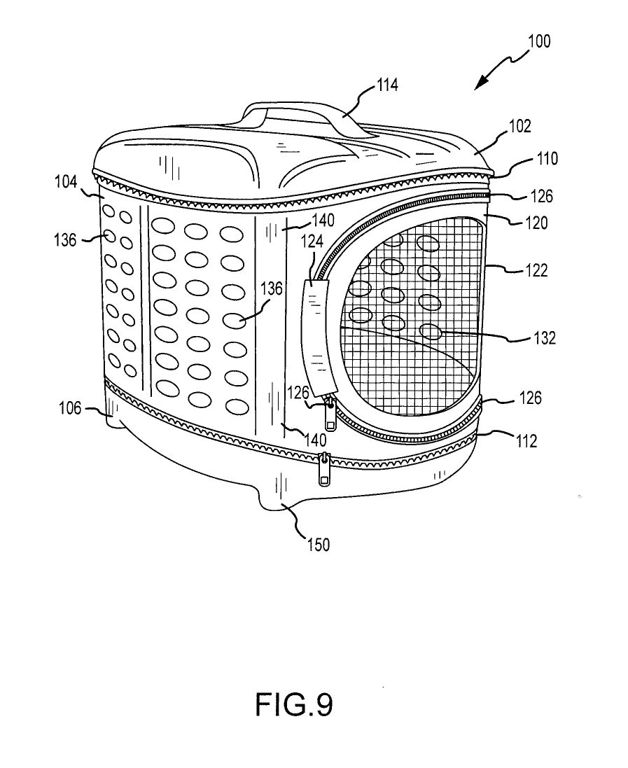

Turning to FIG. 9, another pet housing 100 is illustrated in accordance with an alternative embodiment. The pet housing 100 includes a top portion 102, a middle portion 104 and a bottom portion 104. In some aspects the pet housing 100 is similar to the pet housing 10 described above and shown in FIGS. 1-8. For example, when assembled, portions 102, 104 and 106 form an enclosed area that maybe used to house a pet. Top portion 102 and bottom portion 104 may generally have the same size and shape to accommodate nesting.

Top portion 102 may be selectively interconnected to middle portion 104 using a suitable coupling mechanism, such as the zipper 110. Bottom portion 106 of housing 100 similarly may be selectively coupled to the middle portion with a suitable coupling mechanism, such as zipper 112. Other embodiments may implement ties, Velcro®, snaps, buttons or other such coupling mechanism. In some embodiments, the zippers 110 and 112 may extend around the entire housing 100, and allow the portions 102, 104 and 106 to be completely detachable from one another for purposes such as storage, shipping and point of sale display of housing 100.

Top portion 102 of housing 100 may include a handle 114. In some embodiments, the handle 114 may be positioned at or near the center of the top portion 102. In other embodiments, handles may be provided on the sides of the top portion to allow for two-handed carrying. Moreover, in other embodiments, handle (not shown) maybe provided on the middle portion 104 and/or the bottom portion 106. For example, in some embodiments, handles may have straps that extend underneath the bottom portion 106 to provide support when transporting a pet within the housing 100. When used, such straps may be extendable on two or more sides of the housing 100 and gripped by a user near or above the top portion 102.

Middle portion 104 of housing 100 may include a door 120 providing access to the enclosed area. The door 120 may be selectively opened or closed utilizing a door flap 122 which may be hingedly attached to the middle portion 104. A hinge or axis of rotation for the door flap 122 may be obscured, covered and/or reinforced with a material. In some embodiments, a hinge may take the form of a portion of the door flap 122 being sewn to the middle portion 104 of the housing 100. In other embodiments, the hinge may take the form of a portion of a zipper 126 which may be used to selectively secure the door flap 122 to the middle portion 104 of housing 100 in a closed position utilizing a zipper 126. Additionally, the door flap 122 may include a ventilation mesh 132. In some embodiments, the door flap 122 may be contained within middle portion 104 and may be secured to the middle portion to ensure that door flap is not misplaced or lost when housing 100 is disassembled. In other embodiments, the door flap 122 may be removed from the middle portion 104. Moreover, in some embodiments, the door flap 122 may protrude slightly outward from the surface of the middle portion 104.

The middle portion 104 may be a unitary member. That is, the middle portion 104 is continuous and may take a shape suited to coupling to the top and bottom portions 102 and 106. When decoupled from the top and bottom portions 102 and 106, the middle portions may generally have a cylindrical, tubular, or open-ended box shape, for example. The middle portion 104 may be made up of one or more panels that are coupled together to form the unitary member. In one embodiment, the middle portion may include four panels that are coupled together to form the unitary member. Specifically, the middle portion 104 may include a front panel that includes the door 120, two side panels that may be substantially similarly dimensioned and a back panel. Additionally, panel joints (e.g., the points at which separate panels are joined together) may be reinforced and/or obscured by material 140. The material may help to protect the joints from manipulation by a pet stored in the housing 100 and may provide a more aesthetically pleasing appearance. In some embodiments, one or more panels of the middle portion 104 may include a plurality of ventilation openings 136.

The top and bottom portions 102 and 106 may have shapes that provide certain benefits. For example, the top portion 102 may have a generally convex shape to prevent pooling of liquid, such as rain. Additionally, the convex shape provides additional space within the housing 100 for a pet.

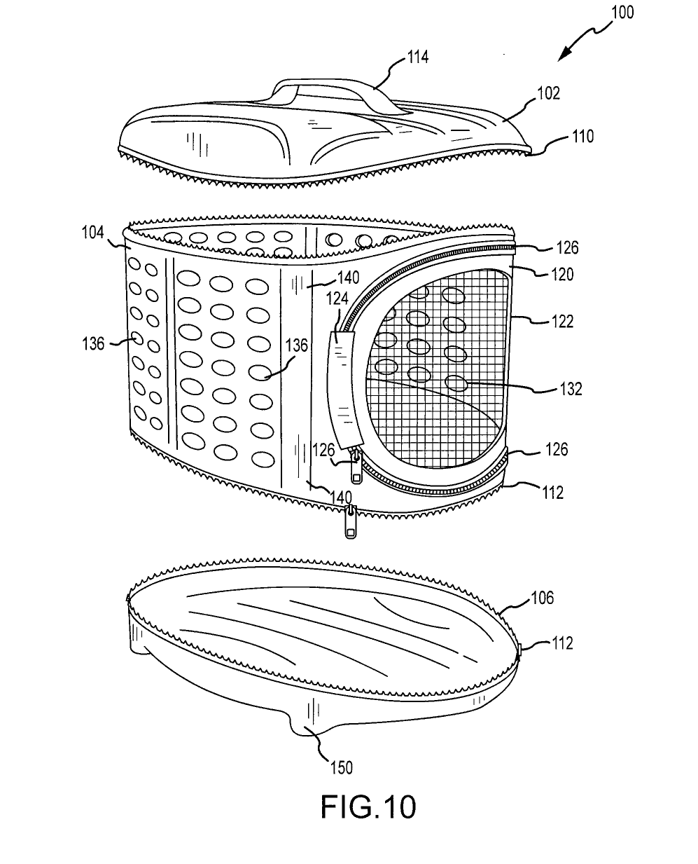

The bottom portion 106 may also have a generally convex shape and may align with the top portion 102 so that they may selectively be coupled together. The bottom portion 106 may also have stability members 150 to help stabilize the housing 100 from rolling over. The stability members 150 may extends outwardly from the bottom portion 106 and downwardly such that they each contact the ground when the housing 100 is placed on the ground. In some embodiments, four or more stability members 150 maybe provided and distributed about the perimeter of the bottom member 150. The bottom portion 106 may also include contours that prevent the entire surface of the bottom portion from contacting the ground. The contours may more easily be seen in FIG. 10, which shows an exploded view of the housing 100 with the top, middle and bottom portions 102, 104 and 106 separated.

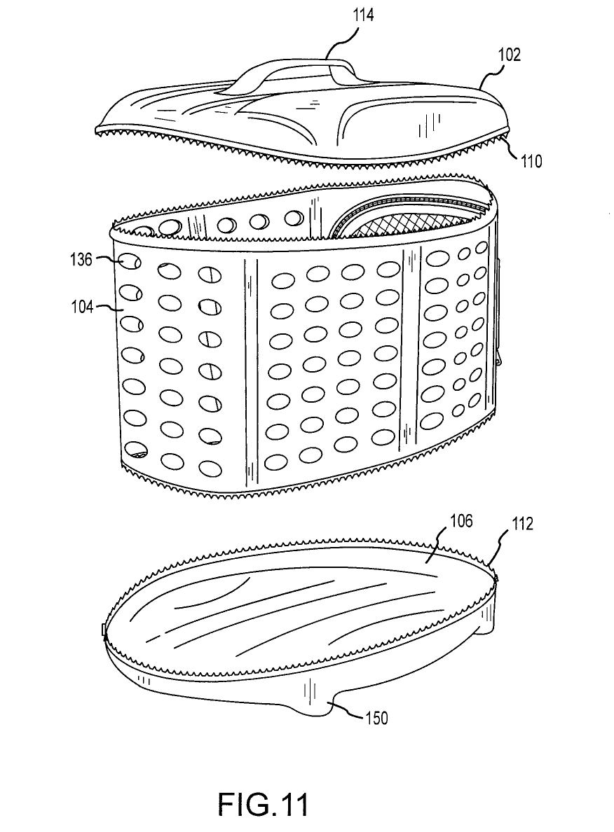

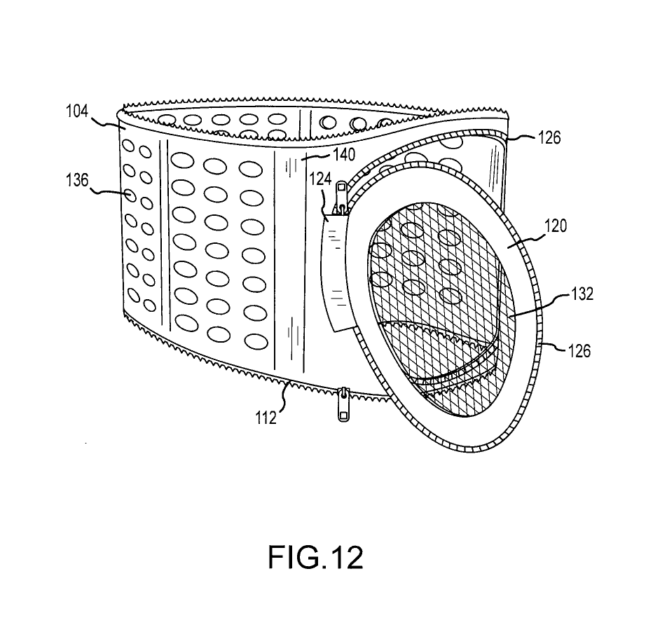

FIG. 11 illustrates the middle portion 104 in a folded position. Generally, the middle portion 104 may be made of material that allows for easy folding. In some embodiments, the middle portion 104 may be folded at or near panel joints of the middle portion. The middle portion 104 may be folded sufficiently to allow for it to fit within the top or bottom portions 102 and 106. FIG. 12 shows the middle portion 104 folded and fitting inside the bottom portion.

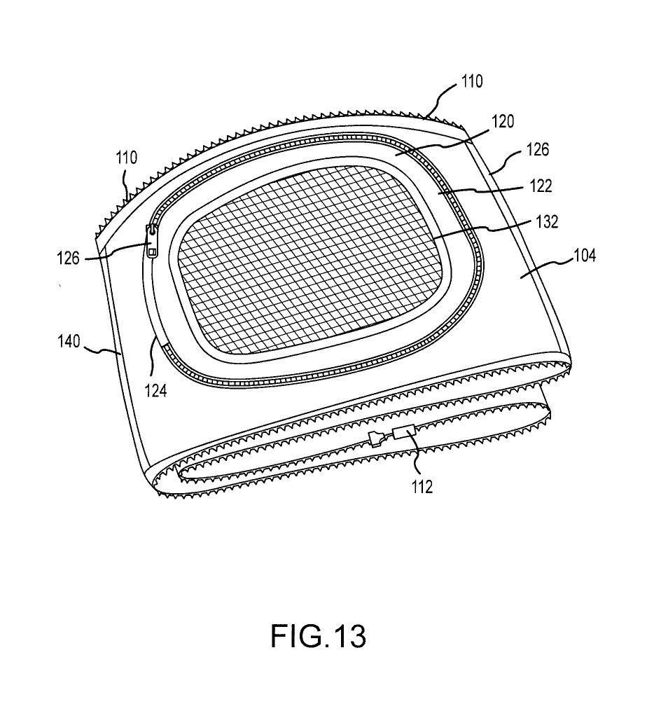

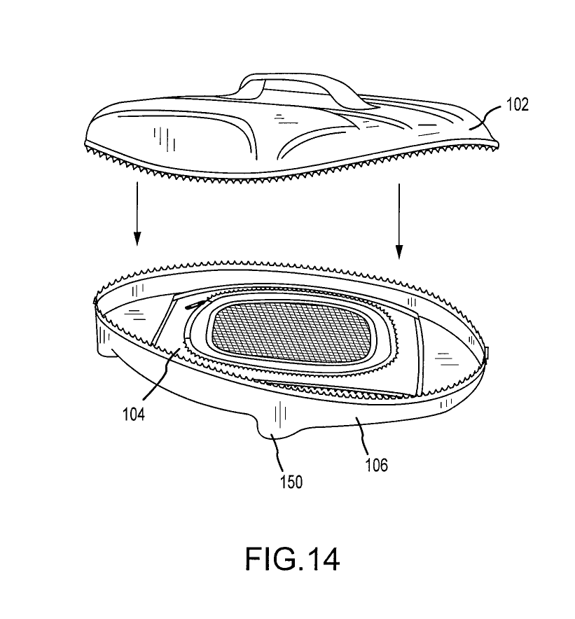

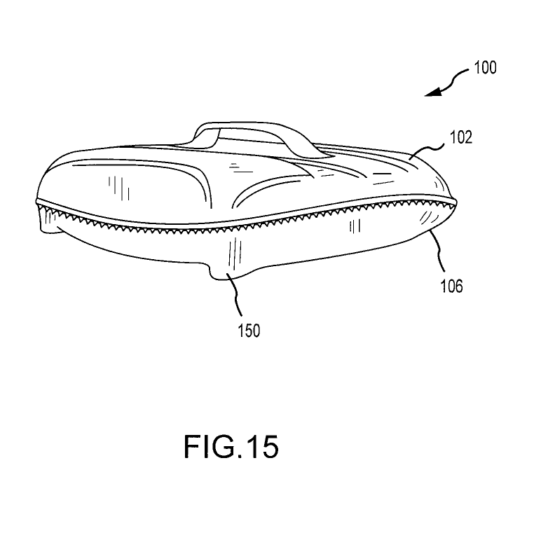

The top portion 102 may be coupled to the bottom portion 106 to encapsulate the middle portion 104 for ease of storage, transport and/or display, as shown in FIG. 13. Specifically, the top portion 102 and bottom portion 106 may be zippered together. Hence, the top and bottom portions 102 and 106 may be selectively secured together and may hold the middle portion 104. The cavity formed between the top and bottom portions 102 and 106 may be sufficient to store items in addition to the middle portion 104. For example, the cavity may store a pillow for a pet, a leash, a toy, and so on.

Generally, the top and bottom portions 102 and 106 may be made of the same material that provides a more rigid structure than the middle portion 104. However, in some embodiments, the top and bottom portions 102 and 106 may be made of different materials. For example, the bottom portion may be made of a more resilient material than the top portion. Moreover, in some embodiments, one or more panels of the middle portion 104 may be made of a different material from other panels.

The foregoing describes some example embodiments of pet housing having selectable separable parts for storage, transport and/or display. Although the foregoing discussion has presented specific embodiments, persons skilled in the art will recognize that changes may be made in form and detail without departing from the spirit and scope of the embodiments to achieve similar functionality and utility to the example embodiments disclosed herein. Moreover, it should be appreciated that features from a particular embodiment may be implemented in another embodiment disclosed herein to achieve a desired functionality. Accordingly, the specific embodiments described herein should be understood as examples and not limiting the scope of the disclosure.

We claim:

1. A pet housing comprising:
a first portion;
a second portion selectively coupled to the first portion; and
a third portion selectively coupled to the second portion, wherein when the first portion is coupled to the second portion and the second portion is coupled to the third portion a pet housing structure is formed; and
wherein further the first and third portions are selectively coupleable to form a cavity.

2. The pet housing of claim 1, wherein the middle portion is encapsulated within the cavity when the first and third portions are selectively coupled together.

3. The pet housing of claim 1, wherein the first and second portions are selectively coupled together with first zipper.

4. The pet housing of claim 3, wherein the second and third portions are selectively coupled together with a second zipper.

5. The pet housing of claim 4, wherein the first and third portions are selectively coupleable using part of the first zipper and part of the second zipper.

6. The pet housing of claim 1, wherein the second portion comprises a selectively closable door flap.

7. The pet housing of claim 6, wherein the door flap comprises a mesh material.

8. The pet housing of claim 6, wherein the door flap is selectively removable from the second portion.

9. The pet housing of claim 1, wherein the second portion is foldable to fit within the cavity.

10. The pet housing of claim 1, wherein the second portion comprises one or more panels coupled together to form a unitary member.

11. The pet housing of claim 10, wherein the second portion comprises four panels successively sewn together.

12. The pet housing of claim 11, wherein at least two of the panels have substantially the same dimensions.

13. The pet housing of claim 11, wherein one or more of the four panels comprises ventilation openings.

14. The pet housing of claim 1, wherein the third portion comprises a plurality of stabilizing members.

15. The pet housing of claim 14, wherein the plurality of stabilizing members extend outwardly and downwardly from the third member.

16. The pet housing of claim 14, wherein the third portion has a generally convex shape.

17. The pet housing of claim 1, wherein the first portion comprises a generally convex shape.

18. The pet housing of claim 1, wherein the first portion comprises a handle.

19. A pet structure comprising:
a convex top portion;
a convex bottom portion selectively coupleable with the top portion to form an enclosure; and
a middle portion selectively coupleable between the top and bottom portion, wherein, when the middle portion is coupled between the top and bottom portion, an enclosed area is formed for housing a pet.

20. A pet housing comprising a plurality of independent members, each independent member comprising a coupling mechanism, wherein each of the plurality of independent members is selectively coupleable with each of the other independent members, and wherein when each independent member is coupled to at least one other independent member an area is defined for housing a pet, wherein further when at least one independent member is not coupled to at least one other independent member the other independent members are selectively coupleable to store the at least one independent member.
